(19) United States
(12) Patent Application Publication
(10) Pub. No.: US 2020/0179955 A1
(43) Pub. Date: Jun. 11, 2020

(54) NOZZLE DEVICE WITH CONCAVE OPENING CONFIGURATION AND METHOD FOR DISPENSING A VISCOUS APPLICATION MEDIUM

(71) Applicant: Dürr Systems AG, Bietigheim-Bissingen (DE)

(72) Inventors: Bernd Kraft, Steinheim-Höpfigheim (DE); Dmitri Noak, Stuttgart (DE)

(21) Appl. No.: 16/349,301

(22) PCT Filed: Nov. 29, 2017
(86) PCT No.: PCT/EP2017/080834

§ 371 Date: May 13, 2019

(30) Foreign Application Priority Data
Nov. 30, 2016 (DE) 10 2016 014 271.5

(51) Int. Cl. B05B 1/04

(52) U.S. Cl. CPC B05B 1/042; B05B 1/044

(57) ABSTRACT

The disclosure relates to a nozzle device for dispensing a viscous application medium in the form of at least one jet (onto a component, preferably for the encircling application of the application medium onto a rabbet, edge or transition joint of the component (100), wherein the at least one jet defines a jet width. The nozzle device comprises an opening configuration for forming at least one slit opening to dispense the application medium and is in particular distinguished in that the opening configuration is concave to effect a narrowing of the jet width towards the dispensing side. The disclosure also relates to an associated method.

### CROSS-REFERENCE TO RELATED APPLICATIONS

This application is a national stage of, and claims priority to, Patent Cooperation Treaty Application No. PCT/EP2017/080834, filed on Nov. 29, 2017, which application claims priority to German Application No. DE 10 2016 014 271.5, filed on Nov. 30, 2016, which applications are hereby incorporated herein by reference in their entireties.

### BACKGROUND

The disclosure relates to a nozzle device for dispensing a viscous, in particular a highly viscous application medium, in the form of at least one jet or at least two jets onto a component, preferably for encompassing application of the application medium onto a fold, an edge or a transition joint of the component. The component is preferably a motor vehicle component (e.g. a vehicle bodywork component), although it can also be, for example, a component of a commercial vehicle (e.g. a commercial vehicle bodywork component, a component of an aircraft, a window (e.g. a window pane) or a facade component.

With regard to the general prior art, reference is made firstly to DE 20 48 865 B.

Making reference to FIG. 16, according to the prior art, in particular, standing seams (e.g. component edges) as occur in particular in the door sill region or on side rails of a motor vehicle, are sealed by means of conventional, robot-guided flat jet nozzles (also known as flatstream nozzles) made of hard metal. In this method, the standing seam is sealed from at least one side and possibly also from both sides with PVC (polyvinyl chloride). So that the underside of the standing seam can be sealed reliably, a robot program is usually created so that the lower edge of the spray jet delivered from the nozzle is applied through a few millimetres below the standing seam and is therefore applied past (“shot past”) the standing seam. The PVC material that is applied on a side of the standing seam becomes partially applied round the seam edge and so seals the lower corrosion-susceptible side of the standing seam.

The requirements for a conventional PVC seam are typically about 15 mm to 25 mm seam width and 1.5 mm to 2.5 mm seam height. So that this can be realized with a structurally limited nozzle, the slit opening of the conventional flat jet nozzle is configured convex so that the jet width of the spray jet enlarges toward the standing seam and thus toward the dispensing side.

A disadvantage of the prior art described above is, in particular, that, as a result of the process, a part of the PVC material is “shot past” at the standing seam. This has the result that the robot guiding the flat jet nozzle and/or the application cell in which the method is carried out becomes soiled and therefore a greater cleaning effort arises. Due to the structural tolerances that are typically present in motor vehicle bodywork, the application usually cannot be set differently. The component tolerances also have the result that the standing seam must be applied in most cases from both sides. Joined sheet metal edges differ, for example, in their length from one bodywork to another.

### BRIEF DESCRIPTION OF THE DRAWINGS

FIG. 1 shows a side view of a nozzle device according to one embodiment of the disclosure,

FIG. 2 shows a longitudinal sectional view along the line A-A of FIG. 1,

FIG. 3 shows a schematic plan view of an opening configuration of the nozzle device of FIGS. 1 and 2,

FIG. 4 shows a perspective view of a nozzle device according to one embodiment of the disclosure,

FIG. 5 shows a side view of the nozzle device of FIG. 4,

FIG. 6 illustrates an application process with a nozzle device according to one embodiment of the disclosure,

FIG. 7 shows a sectional view of a nozzle device according to one embodiment of the disclosure,

FIG. 8 shows a side view of a plate holder for a nozzle device according to one embodiment of the disclosure,

FIG. 9 shows a sectional view of a nozzle device according to one embodiment of the disclosure,

FIG. 10 shows a plan view of the nozzle device of FIGS. 8 and 9,

FIG. 11 shows a sectional view of the nozzle device of FIGS. 8 to 10,

FIG. 12 shows a sectional view of a nozzle device according to one embodiment of the disclosure,

FIG. 13 shows a side view of a nozzle device according to yet another embodiment of the disclosure,

FIG. 14 shows a sectional view of the nozzle device of FIG. 13,

FIG. 15 shows a sectional view of a counterplate for the nozzle device of FIGS. 13 and 14, and

FIG. 16 shows an application process for sealing a standing seam according to the prior art.

### DETAILED DESCRIPTION

The disclosure provides a possibility for dispensing a viscous application medium to a component, preferably for encompassing application of the application medium onto a fold, an edge or a transition joint of the component, by means of which the required quantity of application medium can be reduced.

The disclosure relates to a nozzle device for dispensing a, for example, viscous (in particular highly viscous) application medium in the form of at least one jet onto a component, preferably for encompassing application of the application medium onto a fold (e.g. a standing seam), an edge or a transition joint of the component.

The component is preferably a motor vehicle component, for example, a motor vehicle bodywork.

However, the component can also be a component of a commercial vehicle (e.g. a commercial vehicle bodywork component), a component of an aircraft, a window (e.g. a window pane) or a facade component.

Application fields for the nozzle device are therefore, in particular: motor vehicles, commercial vehicles, aircraft, windows and/or facade construction.

The nozzle device can suitably be configured for dispensing at least one jet or at least two jets.

The at least one jet can define a jet width.

The nozzle device comprises an opening configuration for forming at least one slit opening for dispensing the application medium and is distinguished in particular thereby that the opening configuration is formed concave so that a narrowing of the jet width toward the dispensing side can be brought about.

The jet width can comprise, for example, a single jet if the nozzle device comprises only a single slit opening for dispensing a single jet.

The jet width can encompass, for example, at least two jets if the nozzle device has at least two slit openings for dispensing at least two jets. The at least two openings can be directed, for example, inwardly so that the at least two jets approach one another toward the dispensing side.

By this means, preferably, one or more of the following advantages are achieved:

The consumption of application medium can be reduced.

The soiling of an application cell can be reduced.

A reliable sealing of different fold types, in particular standing seams, can be enabled.

A component measuring system for measuring the (motor vehicle) component can be dispensed with.

A high application speed can be achieved, in particular as compared with application methods with component measurement.

A larger spraying distance between the nozzle device and the (motor vehicle) component can be enabled, e.g. up to 50 mm.

Larger component tolerances can be enabled, for example+/−3 mm to 5 mm.

Due to the simple construction of the nozzle device, preferably there is no additional interfering contour at the applicator and/or at the robot, so that for example, even difficult to access sites such as folds, seams, edges, etc. can be readily reached.

By increasing the outflow rate of the application medium, it can be enabled that even a conventional seam, for example, of PVC can be applied onto the (motor vehicle) component.

The nozzle device is suitable in particular for at least one of the following application possibilities:

Sealing, for example, metallic (motor vehicle) components which are to be welded or glued, e.g. folds (in particular standing seams) or transition joints, but also for example component edges of individual components.

E.g. 3-sided enclosing (encompassing) application (coating) of a, for example, viscous or highly viscous application medium onto a (motor vehicle) component, for the corrosion protection of cut edges on, for example, metal sheets, protection against injury during manual component handling (e.g. in the case of sharp-edged metal sheet edges), protection against edge damage (e.g. in the case of fibre composite materials) and/or abrasion protection.

It is possible that the opening configuration is formed in an end side of the nozzle device and the end side is configured concave.

The opening configuration and thus preferably the at least one slit opening and/or the end side can be configured, for example, substantially concavely curved.

It is possible that the opening configuration is formed concave relative to a longitudinal section along the opening configuration.

The opening configuration can be defined, in particular, by a spraying edge structure, by means of which the application medium is suitably sprayable.

It is possible that the opening configuration and thus the at least one slit opening can be configured substantially concavely curved over at least almost its entire longitudinal extent.

A material cut-out for feeding the application medium to the opening configuration and thus to the at least one slit opening can preferably be incorporated into the nozzle device.

It is possible that the material cut-out opens in the opening configuration and on the dispensing side forms the opening configuration and thus the at least one slit opening.

The material cut-out can be configured, for example, to distribute the application medium over the longitudinal extent of the opening configuration.

It is possible that the material cut-out has a conduit section and a chamber section arranged downstream of the conduit section, wherein the chamber section opens into the opening configuration and/or the passage cross-section of the chamber section is larger than the passage cross-section of the conduit section.

The material cut-out, e.g. in particular the passage cross-section of the chamber section and/or the passage cross-section of the conduit section can preferably be formed in cross-section at least partially substantially flat (e.g. slit-shaped and/or substantially rectangular), but alternatively or additionally also at least partially substantially round (e.g. by way of a bore or in a 3-D print variant).

It is possible that the material cut-out has, for example, inner flanks on both sides externally in order to deflect the dispensing medium inwardly to the at least one slit opening.

It is possible that on both sides externally beside the opening configuration, a protruding horn structure is arranged and preferably the horn structure comprises at least two inwardly formed inner flanks.

It is possible that the inner flanks act upon the application medium emerging from the at least one slit opening so that the narrowing of the jet width is supported and/or the application medium is deflected inwardly.

The opening configuration can comprise at least two slit openings for dispensing at least two jets.

The at least two jets can define a jet width encompassing the at least two jets.

The at least two slit openings can be directed by the concave opening configuration, for example, inwardly so that the at least two jets approach one another toward the dispensing side. Alternatively or additionally, the at least two jets can define a jet width encompassing the at least two jets, wherein the opening configuration is suitably formed concave in order to cause a narrowing of the jet width encompassing the at least two jets toward the dispensing side.

The nozzle device can have, for example, at least one dividing portion for forming and/or separating at least two slit openings for dispensing at least two jets.

The nozzle device can preferably be configured as a nozzle head.

The nozzle head can represent a single-piece integral component so that, for example, components manufactured from one part are thereby included.

The nozzle device can, however, also be configured as a nozzle plate.

The nozzle device configured as a nozzle plate can comprise a counterplate for arrangement adjoining the nozzle plate so that the nozzle device can also be configured as multi-part.

The counterplate can have, for example, at least one of the following features: configured in order to close the opening configuration and thus the at least one slit opening in the peripheral direction, configured in order to close the material cut-out in the peripheral direction, and/or on the dispensing side, formed concave complementary to the opening configuration in order preferably to end substantially flush with the opening configuration.

The at least one jet can be, for example, at least one flat jet.

The opening configuration can define, in particular, a jet plane for the at least one flat jet within which the at least one flat jet extends and within which the jet width narrows toward the dispensing side.

It is possible that the opening width of the opening configuration and/or the opening width of the at least one slit opening has a value transversely to its longitudinal extent of between 0.2 mm and 0.5 mm.

The application medium can comprise, for example, PVC (polyvinyl chloride) and/or a PVC plastisol. In the field of automotive painting, sealing and glueing high viscosity is considered to be above about 1 Pas, with sealing application considered to have a maximum of about 10 Pas and gluing applications to have a maximum of about 2500 Pas.

It is possible that the at least one jet and/or the application medium can be concentrated and/or focused in a targeted manner by setting a suitable outflow quantity and by means of the nozzle shape and nozzle contour disclosed herein.

The features “concave” and “concavely curved” preferably comprise in the context of the disclosure essentially arched concave configurations, although they are not restricted thereto, but can also comprise, for example, linear concave configurations.

The disclosure is not restricted to a nozzle device, but also comprises a method for dispensing a, for example, viscous, in particular highly viscous, application medium in the form of at least one jet onto a component, preferably for encompassing application of the application medium onto a fold, an edge or a transition joint of the component.

In the method, at least one jet or at least two jets can suitably be output.

The at least one jet defines a jet width.

The jet width can comprise, for example, one jet or at least two jets.

The method is preferably carried out with a nozzle device which comprises an opening configuration for forming at least one slit opening from which the application medium is dispensed.

The method is characterised in particular in that the opening configuration is formed concave so that a narrowing of the jet width toward the dispensing side is brought about.

It is possible that the opening configuration and the fold, the edge or the transition joint are oriented substantially at the end side toward one another during the dispensing of the application medium and the application medium nevertheless impacts on two side faces and/or the end face of the fold, the edge or the transition joint.

The method is preferably carried out with a nozzle device as disclosed herein, so that the disclosure made regarding the nozzle device suitably also applies for the method.

The embodiments of the disclosure described making reference to the drawings partially match one another, wherein similar or identical parts are provided with the same reference signs and for their explanation, reference is also made, for the avoidance of repetition, to the description of other embodiments or figures.

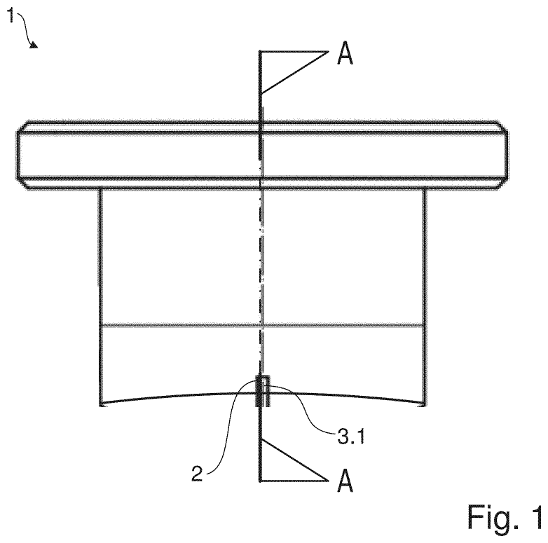

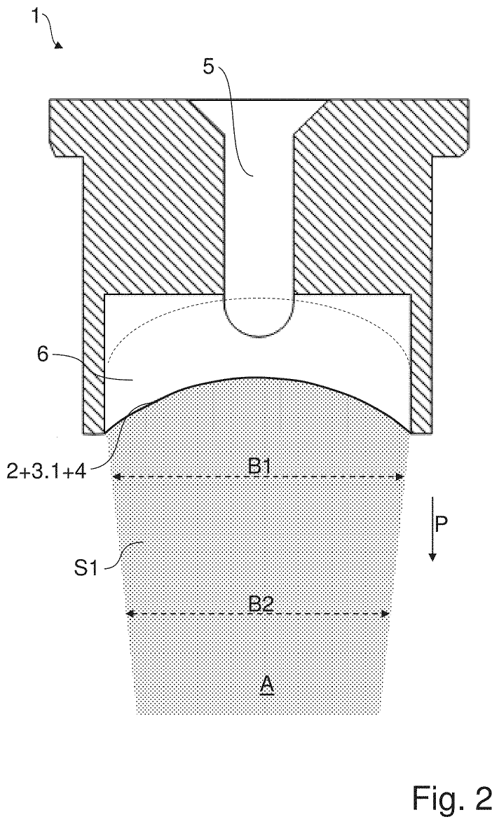

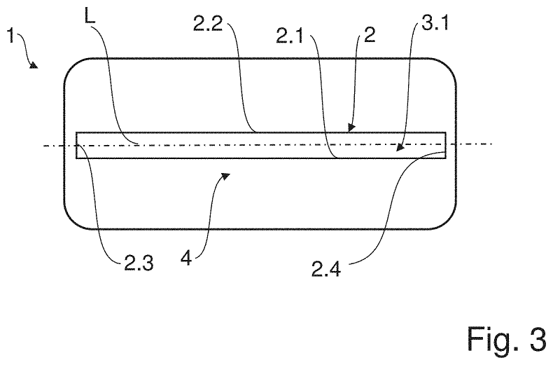

FIG. 1 shows a side view of a nozzle device 1 according to one example of the disclosure, and FIG. 2 shows an associated longitudinal sectional view along the line A-A of FIG. 1, and FIG. 3 shows an associated plan view of the nozzle device 1.

The nozzle device 1 will now be described making reference jointly to FIGS. 1 to 3.

The nozzle device 1 serves to dispense a viscous application medium (e.g. PVC material (polyvinyl chloride)) in the form of a jet S1 onto a component, in particular a motor vehicle component (e.g. a fold, an edge or a transition joint of the motor vehicle component). The motor vehicle component is preferably a vehicle bodywork. The nozzle device 1 is configured as a nozzle head wherein the nozzle head preferably represents a single-piece integral component and can thus be manufactured from a single piece.

The jet S1 is a flat jet and defines a jet width B1, B2 which suitably changes relative to the dispensing direction P of the application medium.

The nozzle device 1 has an opening configuration 2 for forming a slit opening 3.1, by means of which the application medium is dispensed. The opening configuration 2 is defined on the dispensing side by a spraying edge structure 2.1, 2.2, 2.3, 2.4.

The opening configuration 2 and thus the slit opening 3.1 are suitably formed concavely curved and during the dispensing of the application medium onto the motor vehicle component, are oriented substantially at the end side toward the motor vehicle component.

In that the opening configuration 2 and thus the slit opening 3.1 are configured concave, a narrowing of the jet width B1, B2 toward the dispensing side A is caused, so that the jet width B1, B2 narrows relative to the dispensing direction P of the application medium. The jet width B2 is thus smaller than the jet width B1.

The opening configuration 2 defines a jet plane for the jet S1, within which the jet S1 extends and within which the jet width B1, B2 narrows toward the dispensing side A.

Through the narrowing of the jet width B1, B2, the jet S1 can be concentrated such that on impacting upon the motor vehicle component, it encompasses (encloses) it, so that the application medium advantageously does not have to be applied past the motor vehicle component and nevertheless can impact on two side faces of the motor vehicle component and preferably its end face.

Particularly advantageously, the jet S1 can be concentrated by the narrowing of the jet width B1, B2 such that it can be used, for example, for 3-sided encompassing application of the application medium onto a fold, an edge or a transition joint of the motor vehicle component.

The opening configuration 2 is formed concave relative to a longitudinal section A-A along the opening configuration 2 and in a concave formed end side 4 of the nozzle device 1. The opening configuration 2 and thus the slit opening 3.1 are formed concave over at least almost their entire longitudinal extent L.

A material cut-out 5, 6 is incorporated into the nozzle device 1 for feeding the application medium to the opening configuration 2 and thus to the slit opening 3.1.

The material cut-out 5, 6 comprises a conduit section 5 and a chamber section 6 arranged downstream of the conduit section 5, wherein the passage cross-section of the chamber section 6 is larger than the passage cross-section of the conduit section 5. The passage cross-section of the conduit section 5 can be formed, for example, round (suitably by means of boring) and the passage cross-section of the chamber section 6 can be formed substantially flat and slit-shaped.

The material cut-out 5, 6, in particular the chamber section 6, opens in the opening configuration 2 and forms on the dispensing side the opening configuration 2 and therefore the slit opening 3.1.

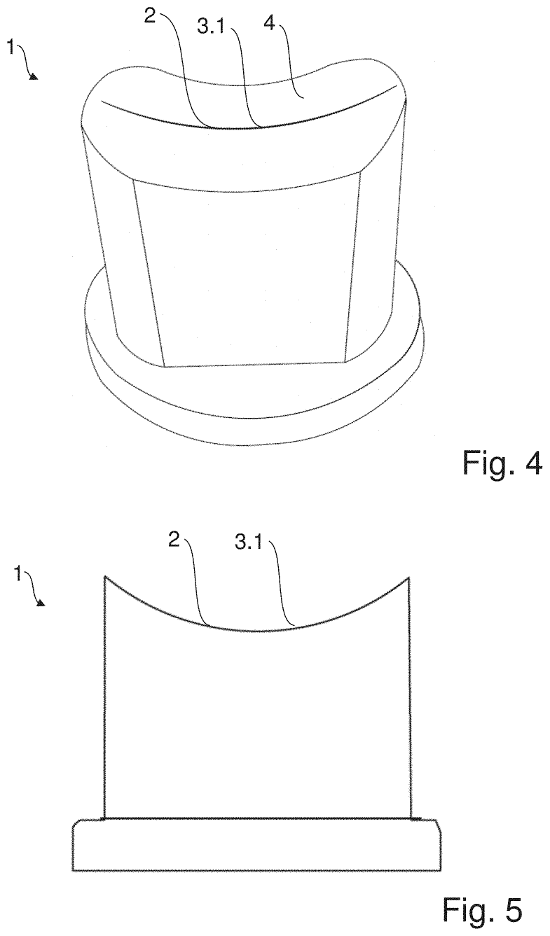

FIGS. 4 and 5 show views of a nozzle device 1 which corresponds substantially to the nozzle device 1 of FIGS. 1 to 3.

FIGS. 4 and 5 show, in particular, a nozzle device 1 configured as a single-piece integral nozzle head.

The opening configuration 2 and thus the slit opening 3.1 are suitably formed concavely curved and are part of a similarly suitably concavely curved end side 4.

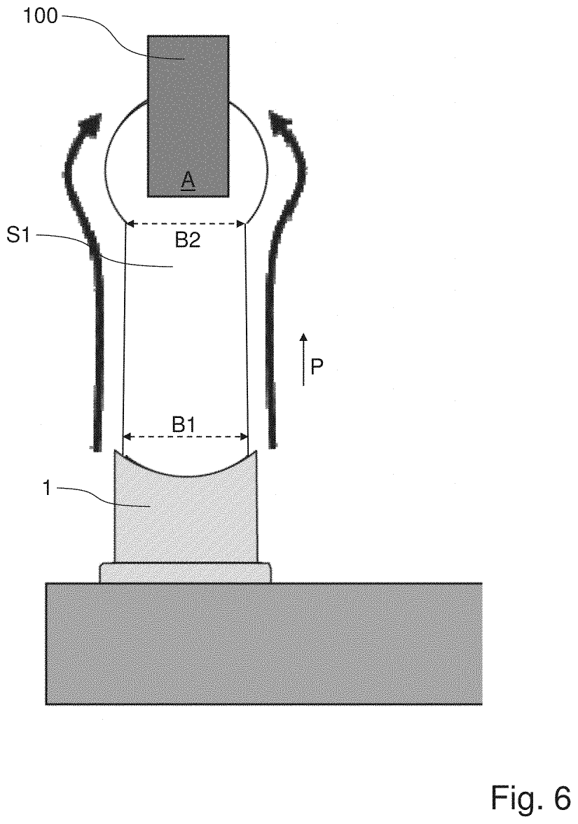

FIG. 6 shows an application process with a nozzle device 1, for example, as shown in FIGS. 1 to 5.

The nozzle device 1 serves for dispensing a viscous application medium in the form of a jet S1 onto a component 100, preferably a motor vehicle component 100, in particular a standing seam of the motor vehicle component 100. The opening configuration 2 and thus the slit opening 3.1 are oriented, during the dispensing of the application medium, substantially at the end side toward the standing seam.

In that the opening configuration 2 brings about a narrowing of the jet width B1, B2 toward the dispensing side A, the jet S1 impacts upon the end face, but also on the two side faces of the standing seam.

The opening configuration 2 therefore enables, in particular, a 3-sided encompassing application of the application medium onto the standing seam.

FIG. 7 shows a sectional view of a nozzle device 1 according to another example.

The nozzle device 1 of FIG. 7 is substantially configured like the nozzle device of FIGS. 1 to 5.

It is, however, a peculiarity that on both sides externally beside the opening configuration 2, a protruding horn structure 7.1, 7.2 is arranged and the horn structure 7.1, 7.2 comprises at least two inwardly formed inner flanks 8.1, 8.2.

The inner flanks 8.1, 8.2 act upon the application medium issued from the slit opening 3.1 so that the narrowing of the jet width B1, B2 is supported and the application medium is deflected inwardly.

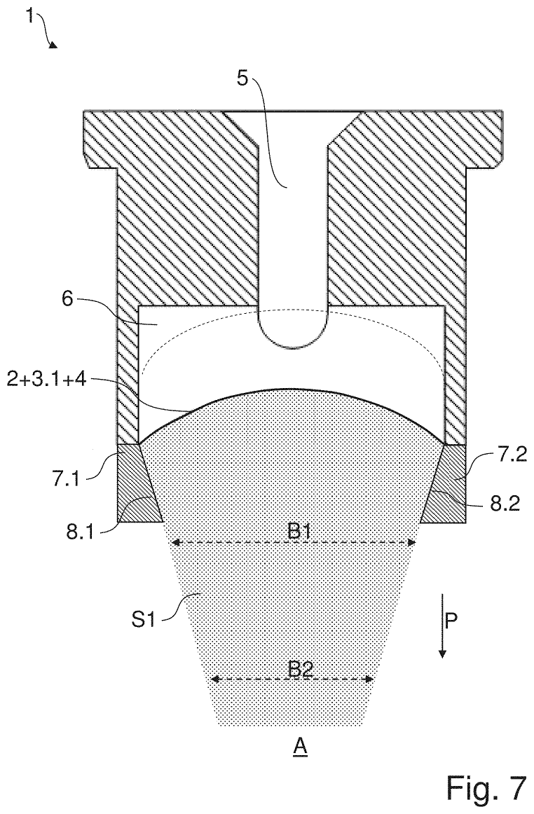

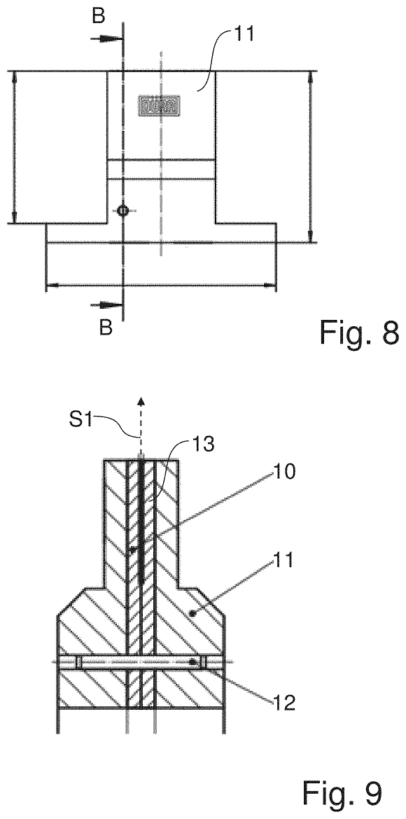

FIGS. 8 to 11 relate to a nozzle device 10 according to another example.

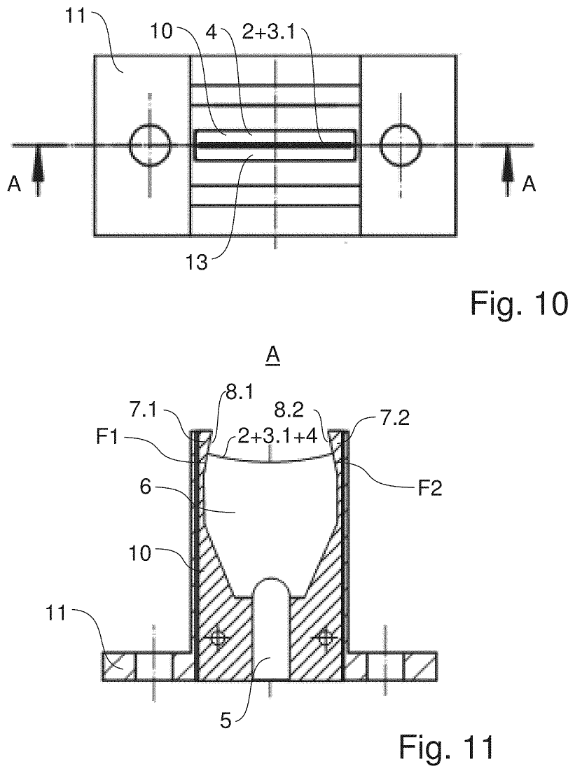

FIG. 8 shows a side view of a plate holder 11 preferably comprising two clamping parts (e.g. clamping plates). FIG. 9 shows a sectional view along the line B-B of FIG. 8. FIG. 10 shows an associated plan view and FIG. 11 shows a sectional view of the nozzle device 10 along the line A-A of FIG. 10.

The nozzle device 10 will now be described making reference jointly to FIGS. 8 to 11.

The nozzle device 10 serves, substantially identically to the nozzle device 1, for dispensing a viscous application medium in the form of a jet S1 onto a motor vehicle component.

The nozzle device 10 has, also substantially identically to the nozzle device 1, an opening configuration 2 for forming a slit opening 3.1, for dispensing the application medium. The opening configuration 2 is suitably formed concave in order to bring about a narrowing of the jet width B1, B2 toward the dispensing side A.

The jet S1 can herein be formed as shown in FIG. 2, 6 or 7.

A peculiarity of the nozzle device 10, however, is that the nozzle device 10 is not configured as a single-piece integral nozzle head, but rather as a nozzle plate with a counterplate 13 to be arranged beside the nozzle plate. The nozzle device 10 and the counterplate 13 are arranged between the two clamping parts of the plate holder 11 in order to be held and fixed thereby. A fixing 12 serves to clamp the two clamping parts of the plate holder 11 and thereby also the nozzle device 10 and the counterplate 13.

The counterplate 13 is formed, on the dispensing side, concave in a complementary manner toward the opening configuration 2 and serves to close the opening configuration 2 and thus the slit opening 3.1 as well as the material cut-out 5, 6 in the peripheral direction.

The nozzle device 10 can optionally comprise the horn structure 7.1, 7.2.

Likewise optionally, the material cut-out 5, 6 can comprise inner flanks F1, F2 on both sides in order to deflect the dispensing medium inwardly toward the slit opening 3.1.

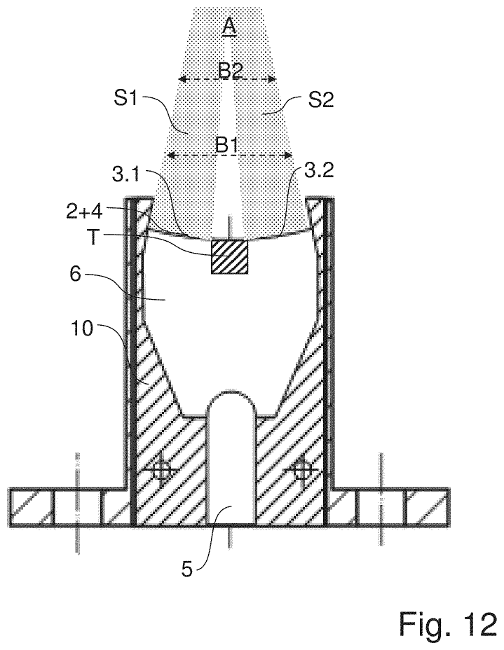

FIG. 12 shows a sectional view of a nozzle device 10 according to another example. The nozzle device 10 of FIG. 12 resembles the nozzle device 10 shown in FIG. 11 and is thus configured as a nozzle plate.

A peculiarity, however, is that the opening configuration 2 of the nozzle device 10 of FIG. 12 comprises two slit openings 3.1, 3.2 for dispensing a viscous application medium in the form of two jets S1, S2.

The two jets S1, S2 define a jet width B1, B2 encompassing the two jets S1, S2.

The opening configuration 2 is concavely formed, so that a narrowing of the jet width B1, B2 encompassing the two jets S1, S2 toward the dispensing side A is caused. The openings 3.1, 3.2 are oriented inwardly through the concave opening configuration 2, so that the jets S1, S2 approach one another toward the dispensing side A.

For forming or separating the two slit openings 3.1, 3.2, the opening configuration 2 comprises a dividing portion T.

The horn structure (7.1, 7.2) shown in FIG. 12 and the inner flanks (F1, F2) of the material cut-out 5, 6 are optional.

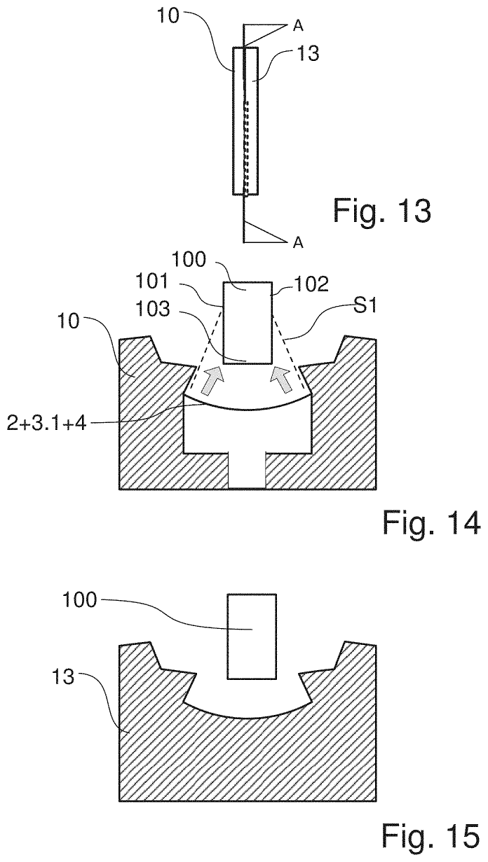

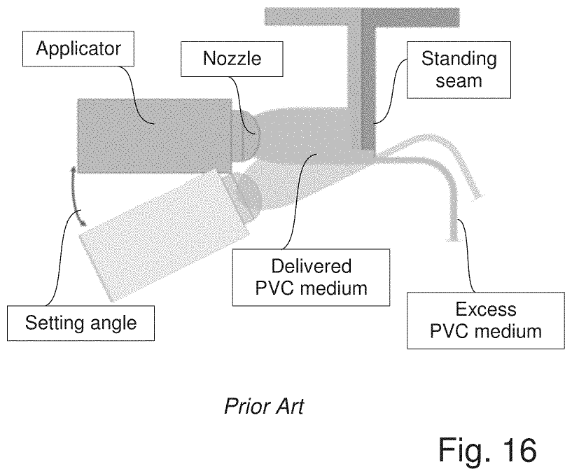

FIG. 13 shows a side view of a nozzle device 10 configured as a nozzle plate together with a counterplate 13 configured in a complementary manner according to another example. FIG. 14 shows a sectional view of the nozzle device 10 of FIG. 13 and FIG. 15 shows a sectional view of the counterplate 13 of FIG. 13.

Similarly to the other nozzle devices 1 and 10, in this embodiment also, a narrowing of the jet width B1, B2 toward the dispensing side A can be caused.

During the dispensing of the application medium, the opening configuration 2 and thus the slit opening 3.1 and a motor vehicle component 100, in particular for example a fold, an edge or a transition joint are substantially oriented at the end side toward one another. Nevertheless, due to the narrowing of the jet width B1, B2 toward the dispensing side A, the application medium impacts onto two side faces 101, 102 and an end face 103 of the motor vehicle component 100.

The disclosure is not restricted to the above described preferred exemplary embodiments. Rather a plurality of variants and derivations is possible which also make use of the inventive concepts and therefore fall within the protective scope. Furthermore, the disclosure also claims protection for the subject matter and the features of the subclaims separately from the features and claims to which they refer.

### REFERENCE SIGNS

1 Nozzle device, preferably nozzle head
2 Opening configuration
2.1 Spraying edge
2.2 Spraying edge
2.3 Spraying edge
2.4 Spraying edge
3.1 Slit opening, preferably for jet S1
3.2 Slit opening, preferably for jet S2
4 End side
5 Material cut-out, in particular conduit section
6 Material cut-out, in particular chamber section
7.1 Horn structure
7.2 Horn structure
8.1 Inner flank (horn structure)
8.2 Inner flank (horn structure)
10 Nozzle device, preferably nozzle plate
11 Plate holder
12 Fixing
13 Counterplate
S1 Jet, preferably flat jet
S2 Jet, preferably flat jet
A Dispensing side
B1 Jet width
B2 Jet width
F1 Inner flank (material cut-out)
F2 Inner flank (material cut-out)
P Dispensing direction of application medium
L Longitudinal extent
T Dividing portion
100 Component, preferably motor vehicle component
101 Side face
102 Side face
103 End face

1.-25. (canceled)

26. Nozzle device for dispensing a viscous application medium in the form of at least one jet onto a component, preferably for encompassing application of the application medium onto a fold, an edge or a transition joint of the component, the at least one jet defining a jet width, comprising:
an opening configuration for forming at least one slit opening for dispensing the application medium, characterised in that the opening configuration is formed concave in order to bring about a narrowing of the jet width toward the dispensing side.

27. Nozzle device according to claim 26, characterised in that the opening configuration is formed in an end side of the nozzle device and the end side is formed concave.

28. Nozzle device according to claim 27, characterised in that the opening configuration and thus the at least one slit opening and/or the end side is formed concavely curved.

29. Nozzle device according to claim 27, characterised in that the opening configuration is formed concave relative to a longitudinal section along the opening configuration.

30. Nozzle device according to claim 27, characterised in that the opening configuration is defined by a spraying edge structure, from which the application medium is sprayable.

31. Nozzle device according to claim 27, characterised in that the opening configuration and thus the at least one slit opening is formed concavely curved over at least almost its entire longitudinal extent.

32. Nozzle device according to claim 27, characterised in that a material cut-out for feeding the application medium to the opening configuration and thus to the at least one slit opening is incorporated into the nozzle device.

33. Nozzle device according to claim 32, characterised in that the material cut-out opens in the opening configuration and thus on the dispensing side forms the opening configuration and thus the at least one slit opening.

34. Nozzle device according to claim 32, characterised in that by means of the material cut-out the application medium is distributable over the longitudinal extent of the opening configuration.

35. Nozzle device according to one of the claim 32, characterised in that the material cut-out comprises a conduit section and a chamber section arranged downstream of the conduit section, wherein the chamber section opens into the opening configuration and the passage cross-section of the chamber section is larger than the passage cross-section of the conduit section.

36. Nozzle device according to one of the claim 32, characterised in that the material cut-out is formed flat and/or round in cross-section.

37. Nozzle device according to one of the claim 32, characterised in that the material cut-out has inner flanks on both sides in order to deflect the dispensing medium inwardly to the at least one slit opening.

38. Nozzle device according to claim 27, characterised in that on both sides externally beside the opening configuration, a protruding horn structure is arranged and the horn structure comprises at least two inwardly formed inner flanks.

39. Nozzle device according to claim 38, characterised in that the inner flanks act upon the application medium issued from the at least one slit opening in order to support the narrowing of the jet width and/or to deflect the application medium inwardly.

40. Nozzle device according to claim 27, characterised in that the opening configuration comprises at least two slit openings for dispensing at least two jets, wherein
the at least two slit openings are directed inwardly so that the at least two jets approach one another toward the dispensing side, and/or
the at least two jets define a jet width encompassing the at least two jets, and wherein the opening configuration is formed concave in order to cause a narrowing of the jet width encompassing the at least two jets toward the dispensing side.

41. Nozzle device according to claim 27, characterised in that the opening configuration comprises at least one dividing portion for forming or separating at least two slit openings for dispensing at least two jets.

42. Nozzle device according to claim 27, characterised in that the nozzle device is configured as a nozzle head and the nozzle head preferably represents a single-piece integral component.

43. Nozzle device according to one of the claim 26, characterised in that the nozzle device is configured as a nozzle plate.

44. Nozzle device according to claim 43, characterised in that the nozzle device comprises a counterplate for arrangement beside the nozzle plate.

45. Nozzle device according to claim 44, characterised in that the counterplate comprises at least one of the following features:
a) configured to close the opening configuration and thus the at least one slit opening in the peripheral direction,
b) configured to close the material cut-out in the peripheral direction,
c) formed concave on the dispensing side complementary to the opening configuration.

46. Nozzle device according to claim 45, characterised in that the at least one jet is at least one flat jet and the opening configuration defines a jet plane for the at least one flat jet within which jet plane the at least one flat jet extends and within which the jet width narrows toward the dispensing side.

47. Nozzle device according to claim 26, characterised in that the opening width of the opening configuration and/or of the at least one slit opening has a value transversely to its longitudinal extent of between 0.2 mm and 0.5 mm.
